(19) United States
(12) Patent Application Publication
(10) Pub. No.: US 2014/0042066 A1
(43) Pub. Date: Feb. 13, 2014

(54) CHANNEL UNIT FOR LIQUID CHROMATOGRAPH

(71) Applicant: ALPS ELECTRIC CO., LTD., Tokyo (JP)

(72) Inventors: Junko Ito, Miyagi-Ken (JP); Hiroyoshi Minakuchi, Kyoto (JP)

(21) Appl. No.: 13/962,438

(22) Filed: Aug. 8, 2013

(30) Foreign Application Priority Data
Aug. 10, 2012 (JP) 2012-177835

(51) Int. Cl. B01D 15/10

(52) U.S. Cl. CPC B01D 15/10
USPC 210/198.2

(57) ABSTRACT

A column container is formed in a bonding portion between a first support plate and a second support plate, and a column is held in the column container. An inlet channel connects the column container to a liquid inlet port. The inlet channel includes a first channel having a small diameter and a second channel having an increasing diameter. An inner surface of the second channel is a hemispherical surface. The radius of the column container is substantially the same as the radius of the hemispherical surface. The distance from an inflow end of the column to the boundary between the first channel and the second channel is substantially the same as the radius of the hemispherical surface.

### CLAIM OF PRIORITY

This application claims benefit of Japanese Patent Application No. 2012-177835 filed on Aug. 10, 2012, which is hereby incorporated by reference in its entirety.

### BACKGROUND

1. Field of the Disclosure

The present disclosure relates to a channel unit in which a column containing a stationary phase for a liquid chromatograph is supported by a supporter.

2. Description of the Related Art

In liquid chromatography, an eluent, which is a mobile phase, is injected into a column including a stationary phase, such as a porous body, together with a sample from an inflow end of the column. Then, the sample is separated into components in the stationary phase.

Japanese Unexamined Patent Application Publication No. 2005-241456 describes a liquid chromatograph including a column that includes a porous monolith made of an organic material or the like and a pair of filters that are respectively disposed adjacent to an inflow end and an outflow end of the column. The column and the filters are held in a bonding portion between two substrates. In the bonding portion between the substrates, a first microchannel connected to an inlet-side filter and a second microchannel connected to an outlet-side filter are formed.

With the liquid chromatograph described in Japanese Unexamined Patent Application Publication No. 2005-241456, a liquid sample and an eluent are mixed together in the first microchannel, and then the mixture is injected into the column from the inflow end of the column through the inlet-side filter. Components of the liquid sample are repeatedly adsorbed to and desorbed from the porous organic material or the like in the column. As a result, the liquid sample is separated into the components, and the components are discharged from the outflow end of the column to the second microchannel through the outlet-side filter. The components of the liquid sample, which have been separated and eluted in the column, each pass through a detector. The detector irradiates the discharged liquid with light, thereby obtaining a detection signal having peak waveforms each corresponding to one of the components.

Although a column used in a liquid chromatograph has a very small diameter, a stationary phase included in the column, such as a porous body, has a certain cross-sectional area. Therefore, if the inflow pressure or the inflow timing of a liquid that is injected into the stationary phase from the inflow end of the column is not uniform across a cross section of the column, the distances that the liquid moves through the column from different points on the cross section differ from each other. As a result, the detector cannot obtain a detection signal having sharp peaks each corresponding to one of the components.

The inflow pressure and the inflow timing of a liquid injected into the stationary phase from the inflow end of the column differ between points on a cross section of the column due to various conditions such as the condition of connection between a microchannel and the inflow end of the column, the difference between the diameter of a cross section of the microchannel and the diameter of the column, and the like. Therefore, it is difficult to design a liquid chromatograph for obtaining a detection signal having ideal peaks.

In the liquid chromatograph described in Japanese Unexamined Patent Application Publication No. 2005-241456, a filter is disposed at the inflow end of the column. In the liquid chromatograph, the column is packed with microparticles, which form a porous body, and the filter is used to prevent the microparticles from flowing out of the column. Therefore, it is difficult, by using the filter, to make the inflow timing and the inflow pressure of a liquid be uniform at different points on a cross section of the column.

### SUMMARY

A channel unit includes a column including a stationary phase for a liquid chromatograph, and a supporter holding the column. A column container, a liquid inlet port, a liquid outlet port, an inlet channel, and an outlet channel are formed in the supporter. The column container holds the column. The inlet channel connects the liquid inlet port to an inflow end of the column. The outlet channel connects outflow end of the column to the liquid outlet port. The inlet channel includes a first channel and a second channel, the first channel having a uniform cross-sectional area, the second channel having a cross-sectional area that gradually increases from a boundary between the first channel and the second channel toward the inflow end of the column. A cross section of the column container, the cross section being perpendicular to an axis of the column container, is circular, an inner surface of the second channel is convex, and a distance from the boundary to the inflow end is substantially the same as a radius of the cross section of the column container.

In the channel unit, the inner surface of the second channel is convex, and the distance from the boundary between the first channel and the second channel to the inflow end of the column is substantially the same as the radius of the cross section of the column container. Therefore, it is more likely that the inflow timing and the inflow pressure of a liquid that flows into the column from every point on the cross section of the column will be uniform. As a result, a detector can obtain a detection signal having sharp peaks corresponding to components of a sample.

### BRIEF DESCRIPTION OF THE DRAWINGS

FIG. 1 is a plan view of a channel unit according to a first embodiment of the present invention;

FIG. 2 is a partial enlarged plan view of an inflow portion a column of the channel unit illustrated in FIG. 1;

FIG. 3 is a sectional view taken along line III-III of FIG. 2;

FIG. 4 is a sectional view taken along line IV-IV of FIG. 2;

FIG. 5 is a sectional view illustrating the structure of the column;

FIG. 6 is a sectional view of a channel unit according to a second embodiment of the present invention, which corresponds to FIG. 3;

FIG. 7 illustrates the result of a fluid simulation using the channel unit according to the first embodiment;

FIG. 8 illustrates the result of a fluid simulation using the channel unit according to the second embodiment;

FIG. 9 illustrates the result of a fluid simulation using a channel unit having a shape that is different from those of the embodiments of the present invention;

FIG. 10 illustrates the result of a fluid simulation using a channel unit having a shape that is different from those of the embodiments of the present invention;

FIG. 11 is a diagram illustrating a detection signal of Example 1;

FIG. 12 is a diagram illustrating a detection signal of Comparative Example 1;

FIG. 13 is a diagram illustrating a detection signal of Comparative Example 2;

FIG. 14 is a diagram illustrating a detection signal of Example 2; and

FIG. 15 is a diagram illustrating a detection signal of Comparative Example 3.

### DESCRIPTION OF THE EXEMPLARY EMBODIMENTS

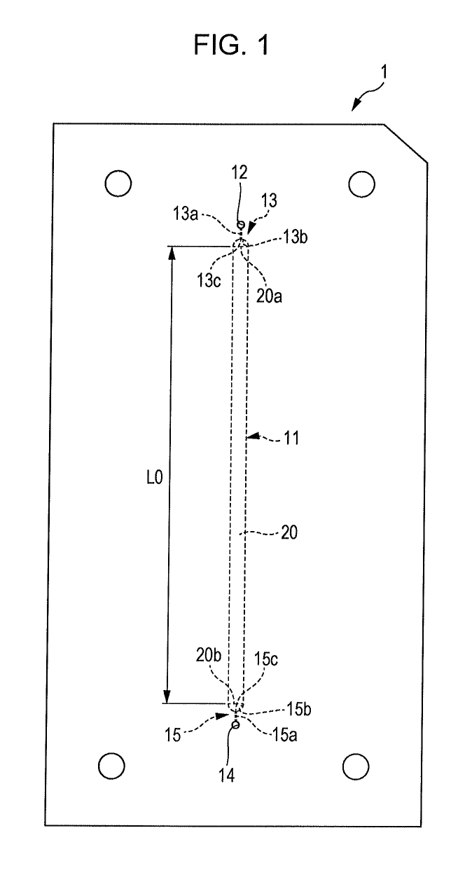

Referring to FIGS. 1 to 4, a channel unit 1 includes a supporter including a first support plate 2 and a second support plate 3 that are stacked in the thickness direction.

The first support plate 2 and the second support plate 3 are made of the same synthetic polymer. Preferably, the synthetic polymer is a cyclic olefin polymer (COP), which is resistant to chemicals and has low fluorescence. However, the synthetic polymer may be appropriately selected in accordance with the properties of a liquid to be used.

The first support plate 2 and the second support plate 3 have the same thickness. The thickness is in the range of about 0.3 to 3.0 mm.

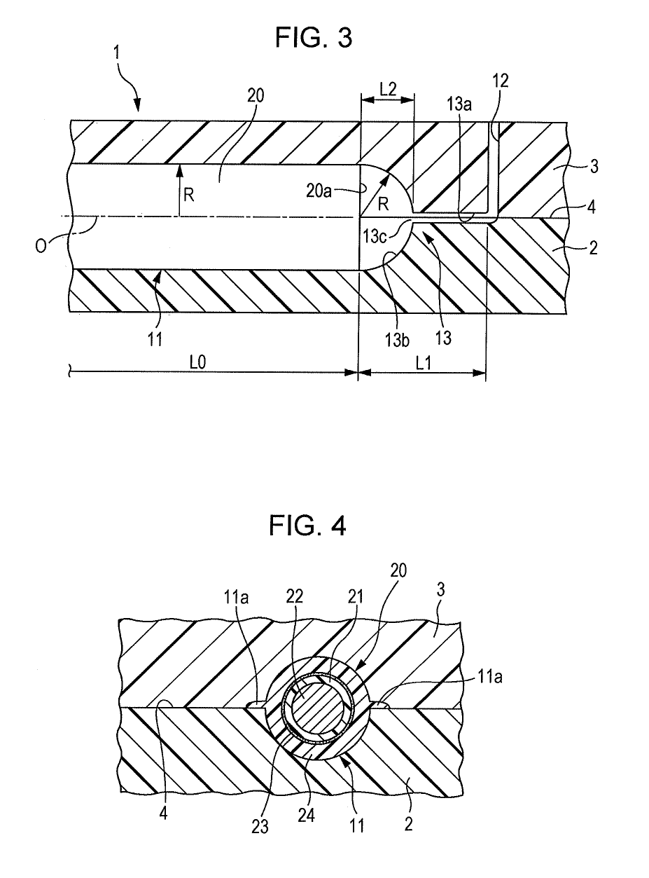

A column container 11 is formed in a bonding portion 4 between the first support plate 2 and the second support plate 3. As illustrated in FIGS. 1 and 3, the length of the column container 11 along an axis O is L0. As illustrated in FIG. 4, the shape of a cross section of the column container 11 perpendicular to the axis O is circular over the entire length L0 and the area of the cross section is constant over the entire length L0. The bonding portion 4 passes through the axis O of the column container 11. That is, the column container 11 is symmetrical about the bonding portion 4.

As illustrated in FIGS. 1 and 3, a liquid inlet port 12 extends through the second support plate 3 in the thickness direction. An inlet channel 13 is formed in the bonding portion 4 between the first support plate 2 and the second support plate 3. The column container 11 is connected to the liquid inlet port 12 through the inlet channel 13. The bonding portion 4 passes through the center of the cross section of the inlet channel 13. That is, the inlet channel 13 is symmetrical about the bonding portion 4.

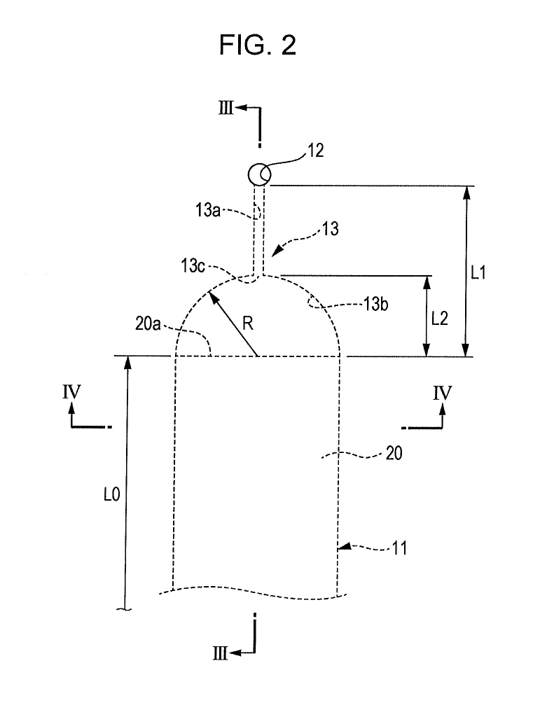

As illustrated in FIGS. 2 and 3, the inlet channel 13 has a length L1 along the bonding portion 4. The length L1 is smaller than the length L0 of the column container 11 along the axis O. Within the length L1, the inlet channel 13 is divided into a first channel 13a and a second channel 13b. In FIGS. 2 and 3, the boundary between the first channel 13a and the second channel 13b is denoted by a numeral 13c. The first channel 13a is connected to the liquid inlet port 12, and the second channel 13b is connected to the column container 11.

The shape of a cross section of the first channel 13a perpendicular to the axis O is circular, and the area of the cross section is constant over its entire length. The shape of an inner surface of the second channel 13b is convex. In the embodiment illustrated in FIGS. 2 and 3, the inner surface is a convexly curved surface. It is preferable that the shape of at least one cross section of the inner surface of the second channel 13b, the cross section including the axis O of the column container 11, be a semicircle. It is more preferable that the inner surface of the entirety of the second channel 13b be a hemispherical surface.

In the channel unit 1 according to the first embodiment, the inner surface of the second channel 13b is a hemispherical surface having a radius R that is substantially the same as the radius R of the column container 11. Here, “the radius R of the hemispherical inner surface of the second channel 13b is substantially the same as the radius R of the column container 11” means that these radii R are the same as each other within the tolerances of design and manufacturing processes.

The radius R of the hemispherical inner surface of the second channel 13b is greater than or equal to five times the diameter of a circular cross section of the first channel 13a. When a cross section of the inlet channel 13 moves across the boundary 13c from the first channel 13a to the second channel 13b, the area of the cross section increases sharply.

As illustrated in FIG. 1, a liquid outlet port 14 is formed in the second support plate 3. An outlet channel 15, which connects the liquid outlet port 14 to the column container 11, is formed in the bonding portion 4 between the first support plate 2 and the second support plate 3. The liquid outlet port 14 extends through the second support plate 3. The length, the cross-sectional shape, and the cross-sectional area of the liquid outlet port 14 are the same as those of the liquid inlet port 12.

The outlet channel 15 is divided into a first channel 15a and a second channel 15b and has a boundary 15c between the channels 15a and 15b. The first channel 15a is connected to the liquid outlet port 14. The length, the cross-sectional shape, and the cross-sectional area of the first channel 15a are the same as those of the first channel 13a of the inlet channel 13. The shape of the inner surface of the second channel 15b of the outlet channel 15 is the same as that of the second channel 13b of the inlet channel 13. The second channel 15b has a hemispherical shape, and the radius R of the second channel 15b is substantially the same as the radius R of the column container 11.

A column 20 is contained in the column container 11.

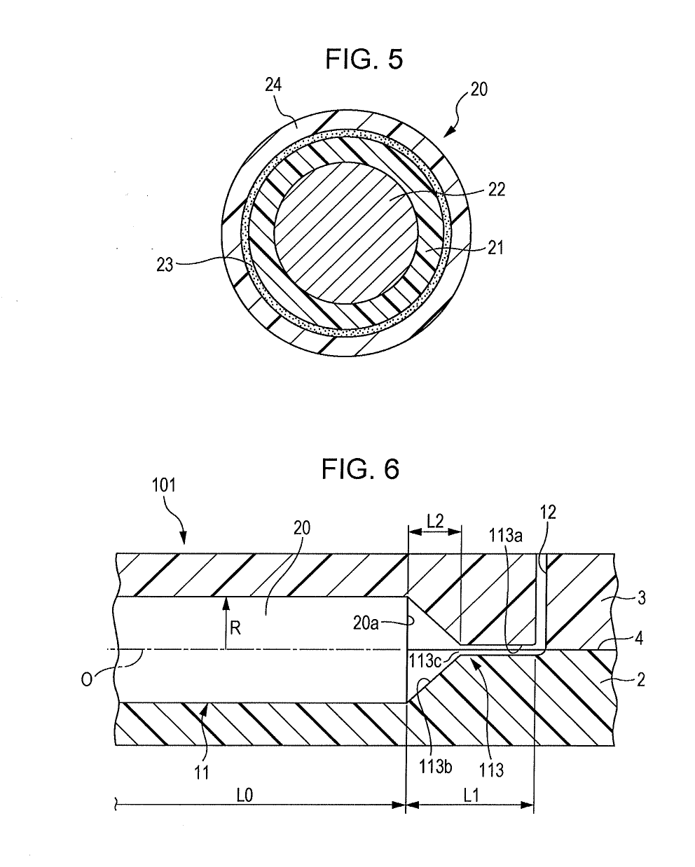

As illustrated in FIGS. 4 and 5, the column 20 includes a tube 21, which is made of a fluorocarbon polymer, and a stationary phase 22 for a liquid chromatograph, which is contained in the tube 21. The stationary phase 22 has a function of separating components of a sample that passes therethrough by adsorbing and desorbing the components of the sample. The stationary phase 22 is, for example, a porous body or an aggregate of microparticles.

The stationary phase 22 may be appropriately selected from those made of various ceramics or polymers in accordance with the type of a sample to be passed therethrough or components of the sample to be separated. In the present embodiment, a monolithic porous body made of a sintered ceramic is used as the stationary phase 22, and in particular, a silica monolith made of silica gel, manufactured by Kyoto Monotech Co., is used.

A cover layer 24 is formed on a surface of the tube 21. The cover layer 24 is made of a polymer material having optical characteristics that are the same as those of the first support plate 2 and the second support plate 3. Preferably, the cover layer 24 is made from a cyclic olefin polymer (COP) film. An adhesive layer 23 is formed between the outer peripheral surface of the tube 21 and the cover layer 24. The tube 21 and the cover layer 24 are bonded to each other through an adhesive of the adhesive layer 23.

A method for setting the column 20 between the first support plate 2 and the second support plate 3 will be described.

First, the column 20, which is covered with the cover layer 24, is heated and pressed to form the column 20 into a shape having a substantially cylindrical outer peripheral surface.

A bonding surface of the first support plate 2 and a bonding surface of the second support plate 3 are irradiated with vacuum UV, and then the column 20 is placed in the column container 11 between the first support plate 2 and the second support plate 3. Subsequently, the first support plate 2 and the second support plate 3 are heated and pressed so that the first support plate 2 and the second support plate 3 are brought into close contact with each other and bonded to each other without using an adhesive.

As illustrated in FIG. 4, extension gaps 11a may be formed in the second support plate 3 so as to extend sideways from the column container 11. In this case, a part of the cover layer 24 enters the extension gaps 11a when the first support plate 2 and the second support plate 3 are pressed against each other. Thus, the cover layer 24 on the column 20 and the inner surface of the column container 11 can more closely contact each other.

As illustrated in FIGS. 2 and 3, an inflow end 20a of the column 20 is located at the boundary between the column container 11 and the second channel 13b of the inlet channel 13. Here, the inflow end 20a of the column 20 is an end surface of the stationary phase 22 disposed in the column 20. The distance L2 from the inflow end 20a of the column 20, that is, the end surface of the stationary phase 22, to the boundary 13c between the first channel 13a and the second channel 13b of the inlet channel 13 is substantially the same as the radius R of the hemispherical inner surface of the second channel 13b, and is also substantially the same as the radius R of the column container 11.

Here, “the distance L2 is substantially the same as the radius R” means that, as described above, the distance L2 and the radius R are the same within the tolerances of design and manufacturing processes. In the present invention, a case where the distance L2 is in the range of 0.9 to 1.1 times the radius R may be included in the meaning of “the distance L2 and the radius R are substantially the same.” It is preferable that the distance L2 be in the range of 0.95 to 1.05 times the radius R.

As illustrated in FIG. 1, the column 20 has an outflow end 20b. The outflow end 20b is an end surface of the stationary phase 22, which is held in the column 20. The distance from the boundary 15c between the first channel 15a and the second channel 15b of the outlet channel 15 to the outflow end 20b is substantially the same as the radius R.

Next, the operation of a liquid chromatograph including the channel unit 1 will be described.

A liquid, which is a mixture of analytes and an eluent, is supplied to the inflow end 20a of the column 20 through the liquid inlet port 12 and the inlet channel 13.

The liquid supplied to the inlet channel 13 passes through the first channel 13a, which has a small cross-sectional area. Because the cross-sectional shape of the first channel 13a is circular, the flow rate of the liquid is the highest at the axis of the first channel 13a and the lowest at a portion adjacent to the inner surface of the first channel 13a. When the liquid moves to the second channel 13b, which has a large cross-sectional area, the pressure of the liquid decreases sharply as the volume of the channel significantly increases. After the second channel 13b has been filled with the liquid, the liquid flows into the stationary phase 22 from the inflow end 20a of the column 20, that is, from the end surface of the stationary phase 22.

Here, in the case where the inner surface of the second channel 13b is hemispherical, it is more likely that the liquid with which the second channel 13b is filled will apply a uniform pressure to every point on the inner surface of the second channel 13b. Because a pressure applied to the inflow end 20a of the column 20 is generated due to reaction of the pressure acting on every point on the hemispherical inner surface, the difference in liquid pressures applied to different points on the circular end surface of the stationary phase 22 is small. In particular, in the case where the distance from the end surface of the stationary phase 22 to the boundary 13c is substantially the same as the radius R of the hemispherical surface, the second channel 13b, which is adjacent to the end surface of the stationary phase 22, has a hemispherical shape. Therefore, it is more likely that the pressure applied to the hemispherical inner surface will be uniform, and therefore it is more likely that the pressure applied to every point on the circular end surface of the stationary phase 22 will be uniform.

As a result, when the liquid moves in the column 20 in the axial direction, the differences in the inflow timing, the pressure, and the flow rate of the liquid at different points on a cross section of the column 20 are reduced.

In the stationary phase 22 of the column 20, components of a sample included in the liquid are independently adsorbed and desorbed, so that the times required for the components to reach the outflow end 20b of the column 20 differ from each other. As a result, the sample can be separated into the components. The separated components are supplied to a detector through the outlet channel 15 and the liquid outlet port 14. The detector irradiates the discharged liquid with light, thereby obtaining a detection signal having peaks each corresponding to a component.

As described above, the difference in the pressure of liquid between different points on a circular cross section of the stationary phase 22 is reduced. Therefore, the difference in the timings at which portions of each of the components that has been separated in the stationary phase 22 are sent to the detector is reduced. As a result, a detection signal having sharp peaks can be obtained.

### Second Embodiment

Referring to FIG. 6, a channel unit 101 according to a second embodiment of the present invention includes an inlet channel 113, which is divided into a first channel 113a and a second channel 113b at a boundary 113c. The shape of a cross section of the first channel 113a perpendicular to the axis O is circular.

The shape of a cross section of the second channel 113b taken along a plane including the axis O is isosceles triangular. The three-dimensional shape of the second channel 113b is conical. The distance L2 from the boundary 113c to the inflow end 20a of the column 20 is substantially the same as the radius R of a cross section of the column container 11 perpendicular to the axis O.

Because the radius R is substantially the same as the distance L2, an advantage the same as that of the channel unit 1 according to the first embodiment can be obtained by using the channel unit 101 according to the second embodiment.

Fluid Simulation

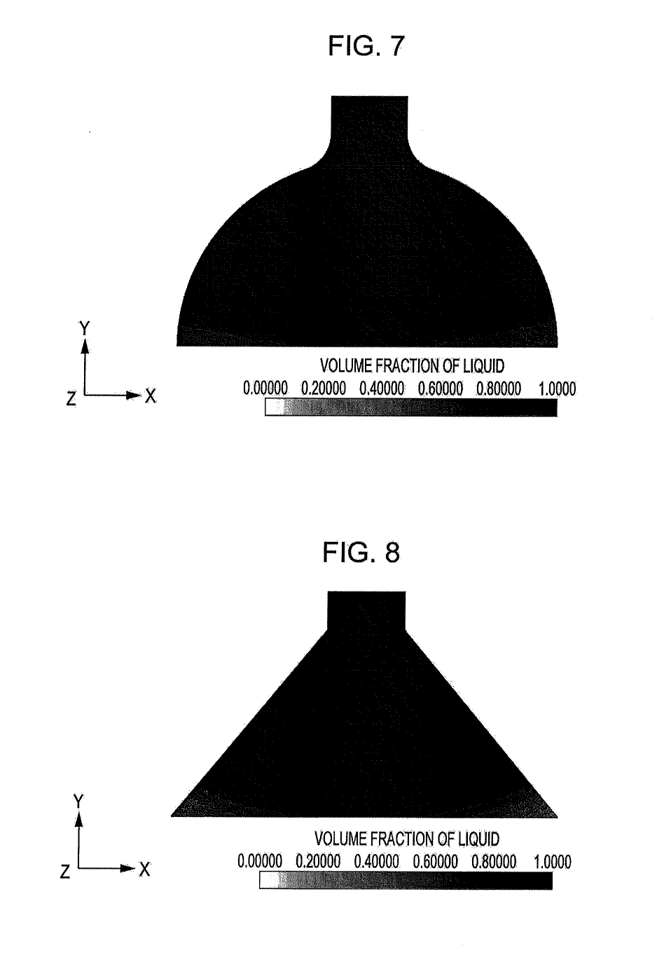

FIGS. 7 to 10 illustrate the results of fluid simulations using a finite element method, which were performed using the channel units according to the embodiments and channel units having structures different from those of the embodiments.

FIGS. 7 to 10 are each a sectional view, taken along a plane including the axis O, of a channel unit at a time when a liquid, which has flowed into the inlet channel 13 or 113, reaches the inflow end 20a of the column 20. The shaded region in each figure represents the liquid.

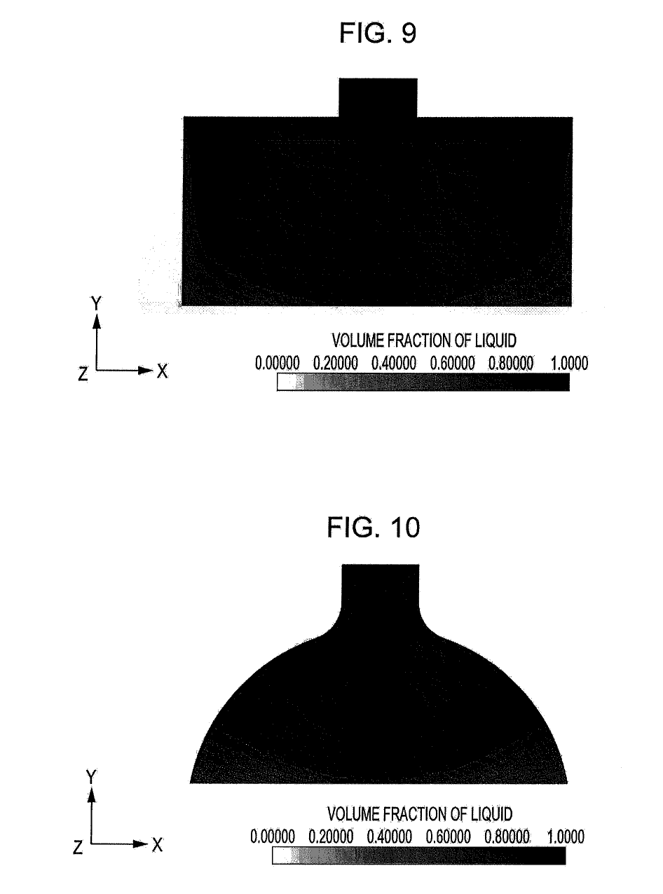

FIG. 7 illustrates the inlet channel 13 of the channel unit 1 according to the first embodiment, and FIG. 8 illustrates the inlet channel 113 of the channel unit 101 according to the second embodiment. FIGS. 9 and 10 illustrate inlet channels having structures different from those of the embodiments of the present invention. In the inlet channel illustrated in FIG. 9, a second channel has a cylindrical space, and the inlet channel has a uniform cross-sectional area from the boundary between the first channel and the second channel to the inflow end 20a of the column 20. In the inlet channel illustrate in FIG. 10, the distance L2 is 0.8 mm, which is smaller than that of the first embodiment.

With each of the inlet channels illustrated in FIGS. 7 and 8, the difference between the time at which a liquid surface reached a central portion of the inflow end 20a and the time at which the liquid reached a peripheral portion of the second channel was small. Therefore, it was shown that the liquid, which included analytes, uniformly flowed into the column 20 through every portion of the inflow end 20a.

In contrast, with the inlet channels illustrated in FIGS. 9 and 10, the difference between the time at which a liquid surface reached a central portion of the inflow end 20a and the time at which the liquid reached a peripheral portion of the second channel was large. Therefore the liquid, which included analytes, could not uniformly flow into the column 20 through every portion of the inflow end 20a. That is, there was a time lag between the time at which the liquid flowed into the column 20 through the central portion of the inflow end 20a and the time at which the liquid flowed into the column 20 through the peripheral portion of the inflow end 20a. Therefore, separation performance was low.

### EXAMPLES

### Example 1

In the channel unit 1 according to the first embodiment illustrated in FIGS. 1 to 5, the radius R of each of the column container 11 and the hemispherical inner surface of the second channel 13b was 1.0 mm, and the radius of the cross section of the first channel 13a was 0.1 mm.

A silica monolith was used as the stationary phase 22. The radius of the cross section of the column 20 was 1.0 mm, and the length L0 of the column 20 in the axial direction was 50 mm.

The distance L2 from the inflow end 20a of the column 20, that is, an end surface on the inlet side of the stationary phase 22, to the boundary 13c between the first channel 13a and the second channel 13b was 1.0 mm.

A liquid mixture of a sample and an eluent was injected from the liquid inlet port 12 with a pressure of about 3.4 MPa.

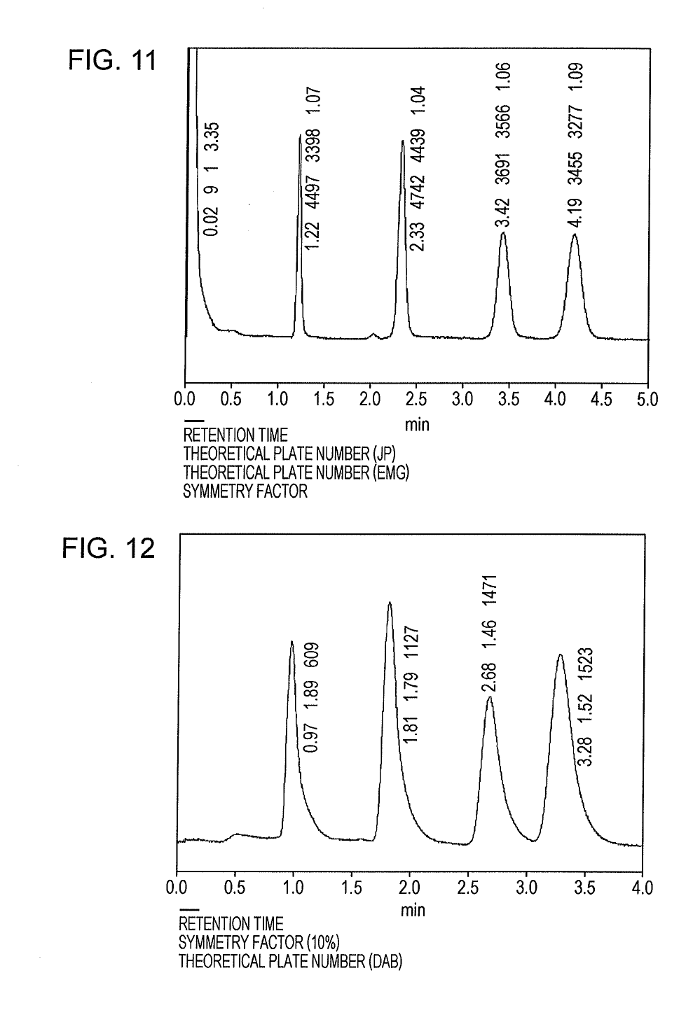

FIG. 11 illustrates a detection output of liquid chromatography in this case.

### Comparative Example 1

The supporter and the column 20 the same as those of Example 1 were used. The distance L2 from the inflow end 20a of the column 20, that is, an end surface on the inlet side of the stationary phase 22, to the boundary 13c between the first channel 13a and the second channel 13b was 0.5 mm.

The sample and the eluent the same as those of Example 1 were used. The sample and the eluent were injected from the liquid inlet port 12 with a pressure the same as that of Example 1.

FIG. 12 illustrates a detection output of liquid chromatography in this case.

### Comparative Example 2

The supporter and the column 20 the same as those of Example 1 were used. The distance L2 from the inflow end 20a of the column 20, that is, an end surface on the inlet side of the stationary phase 22, to the boundary 13c between the first channel 13a and the second channel 13b was 2.0 mm.

The sample and the eluent the same as those of Example 1 were used. The sample and the eluent were injected from the liquid inlet port 12 with a pressure the same as that of Example 1.

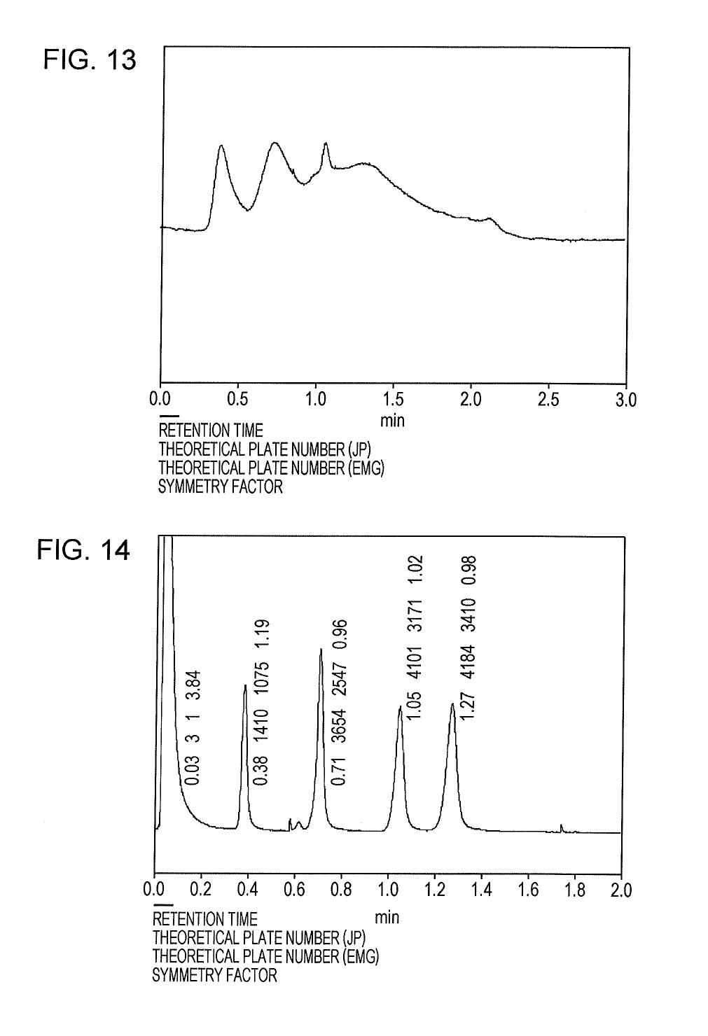

FIG. 13 illustrates a detection output of liquid chromatography in this case.

### Example 2

The radius R of each of the column container 11 and the hemispherical inner surface of the second channel 13b was 0.5 mm, and the radius of the cross section of the first channel 13a was 0.5 mm.

A silica monolith was used as the stationary phase 22. The radius of a cross section of the column 20 was 0.5 mm, and the length L0 of the column 20 in the axial direction was 50 mm.

The distance L2 from the inflow end 20a of the column 20, that is, an end surface on the inlet side of the stationary phase 22, to the boundary 13c between the first channel 13a and the second channel 13b was 0.5 mm.

A liquid mixture of a sample and an eluent was injected from the liquid inlet port 12 with a pressure of about 7.1 MPa.

FIG. 14 illustrates a detection output of liquid chromatography in this case.

### Comparative Example 3

The supporter and the column 20 the same as those of Example 2 were used. The distance L2 from the inflow end 20a of the column 20, that is, an end surface on the inlet side of the stationary phase 22, to the boundary 13c between the first channel 13a and the second channel 13b was 0.25 mm.

The sample and the eluent the same as those of Example 1 were used. The sample and the eluent were injected from the liquid inlet port 12 with a pressure the same as that of Example 1.

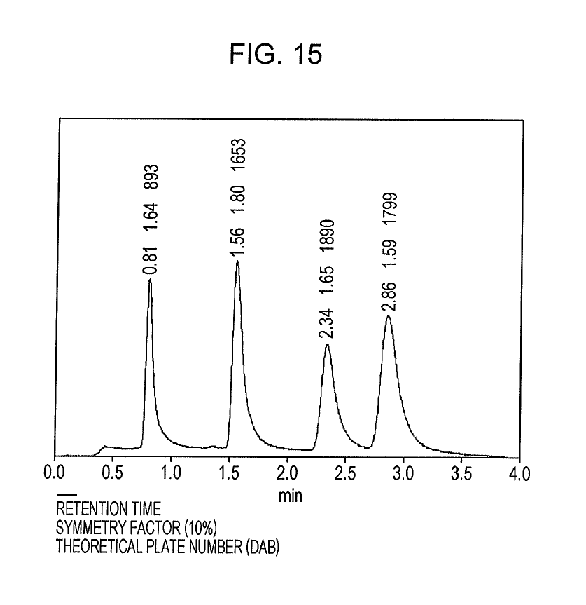

FIG. 15 illustrates a detection output of liquid chromatography in this case.

### Comparative Example 4

The supporter and the column 20 the same as those of Example 2 were used. The distance L2 from the inflow end 20a of the column 20, that is, an end surface on the inlet side of the stationary phase 22, to the boundary 13c between the first channel 13a and the second channel 13b was 1.0 mm.

The sample and the eluent the same as those of Example 1 were used. The sample and the eluent were injected from the liquid inlet port 12 with a pressure the same as that of Example 1.

Although the detection output of liquid chromatography is not illustrated, the degree of separation was very low as in the case illustrated in FIG. 13.

The detection signals illustrated in FIGS. 11 and 14 have sharp peak values corresponding to the detected components. In contrast, in FIGS. 12 and 15, the detection precision of peak values is low. In FIG. 13, the detection precision of separation of components is considerably low.

As can be understood from the examples described above, it is preferable that the distance from the boundary 13c to the inflow end 20a of the column 20 be in the range of 0.9 to 1.1 times the radius R, which is the radius of each of the column container and the inner surface of the second channel 13b.

What is claimed is:

1. A channel unit comprising:
a column including a stationary phase for a liquid chromatograph; and
a supporter holding the column,
the supporter having a column container, a liquid inlet port, a liquid outlet port, an inlet channel, and an outlet channel are formed in, the column container holding the column, the inlet channel connecting the liquid inlet port to an inflow end of the column, the outlet channel connecting an outflow end of the column to the liquid outlet port,
wherein the inlet channel includes a first channel and a second channel, the first channel having a uniform cross-sectional area, the second channel having a cross-sectional area that gradually increases from a boundary between the first channel and the second channel toward the inflow end of the column, and
wherein a cross section of the column container, the cross section being perpendicular to an axis of the column container, is circular, an inner surface of the second channel is convex, and a distance from the boundary to the inflow end is substantially the same as a radius of the cross section of the column container.

2. The channel unit according to claim 1, wherein a shape of a cross section of the inner surface of the second channel, the cross section being taken along a plane including the axis of the column container, is semicircular.

3. The channel unit according to claim 2, wherein the inner surface of the second channel is a hemispherical surface.

4. The channel unit according to claim 1, wherein a shape of a cross section of the inner surface of the second channel, the cross section being taken along a plane including the axis of the column container, is isosceles triangular.

5. The channel unit according to claim 4, wherein the inner surface of the second channel is a circular conical surface.

6. The channel unit according to claim 1, wherein the distance from the boundary to the inflow end is in a range of 0.9 to 1.1 times the radius of the cross section of the column container.

7. The channel unit according to claim 1, wherein the radius of the cross section of the column container is equal to or greater than five times a diameter of the first channel.

8. The channel unit according to claim 1, wherein the stationary phase for the liquid chromatograph comprises a monolithic porous body made of a sintered ceramic.

9. The channel unit according to claim 8, wherein the porous body comprises porous silica.
